(19) United States
(12) Patent Application Publication
(10) Pub. No.: US 2015/0132125 A1
(43) Pub. Date: May 14, 2015

(54) Personal Fan Apparatus

(71) Applicant: Beth A. Meunier, Manitowoc, WI (US)

(72) Inventor: Beth A. Meunier, Manitowoc, WI (US)

(21) Appl. No.: 14/538,378

(22) Filed: Nov. 11, 2014

Related U.S. Application Data
(60) Provisional application No. 61/902,481, filed on Nov. 11, 2013.

(51) Int. Cl. F01D 25/24

(52) U.S. Cl. CPC F01D 25/24; F05D 2230/60
USPC 415/213.1; 29/888.025

(57) ABSTRACT

A method and apparatus for providing a portable source of air flow. The apparatus provides a base on casters, a support member coupled to the base, and a panel connected to the support member. The panel comprises at least one plate containing a plurality of apertures to expel air traveling from the blower. The panel position is adjustable relative to the base and the apparatus is free-standing and portable.

The device is effective for people in need of a constant air source. The mobility allows the device to move with the person as he or she gets dressed, returns to bed rest, or simply desires a controlled temperature while walking into another room. The device can be positioned directly next to an individual, or if necessary positioned above. The adjustable panel position allows the panel to have directional air flow in ways not possible with conventional air systems.

This application claims benefit from provisional patent application No. 61/902,481, filed Nov. 11, 2013.

### FIELD

The present disclosure relates to personal fan apparatuses.

### BACKGROUND

In many situations, a person may not have access to a comfortable flow air at a desirable temperature. For bed-ridden patients, people with burns or other painful skin sensitivities, and others, going outside or moving to adjust thermostats may not be an option. In other circumstances, people taking baths or showers in drafty homes may not have a way to regulate the air temperature around them.

Devices are known that claim personal dryers. One such device provides a wall-mounted body dryer that comprises a plurality of nozzles that distribute warming air onto a person who is standing in front of the dryer. Another device provides a hot air dryer that is suspended from the ceiling. The dryer may be raised or lowered and comprises a skirt that encloses a user within the unit when delivering air flow.

The present disclosure relates generally to method and apparatus for providing a portable source of air flow. In addition, the present disclosure pertains to methods for construction of the apparatus.

### SUMMARY

The present disclosure relates to a method and apparatus for providing a portable source of air flow. The apparatus provides a base on a plurality of casters and a support member coupled to the base, the support member being connection to the base at the first end of the support member. A connection member connects the support member to a panel, and the front of the panel comprises at least one plate having a plurality of apertures to expel air traveling from a blower. The panel position is adjustable relative to the base and the overall personal fan apparatus is free standing and portable.

The personal fan disclosed comprise a base permitting the fan to move across a horizontal surface. A support member having a first and second end is attached to the base at the first end of the support member. A folding arm having a first and second end is connected to the support member. The first end of the folding arm is connected to the support member. The panel has a front and back. The front of the panel comprises as least one plate having a plurality of apertures. The panel is attached to the connecting arm. Alternately, the panel could be attached directly to the support member. A blower is connected to the panel to force ambient air through the panel and out the apertures when receiving a signal from a controller unit.

In use, the device is effective in settings where a person may need assistance or is in need of a constant air source. For example, the device may be utilized in a shower for a person who is in a hospital. The device could also be used after a shower to help warm a weak individual who may have symptoms that include poor blood flow. The blower can direct warmed air to help evaporate moisture on the body to aid conventional towel drying. The mobility of the device has further utility by being able to move with the person as he or she gets dressed, returns to bed rest, or simply would like a controlled temperature while walking into another room.

The adjustability of the panel position is a useful addition, especially for bed-ridden or recovering individuals. Often times, a bed-ridden individual does not receive adequate air circulation or an air conditioning unit does not properly circulate air in the room. The present invention overcomes these limitations by being used in a mobile and adjustable way. The device can be positioned directly next to an individual, or if necessary positioned above. The adjustable panel position allows the panel to have directional air flow in ways not possible with conventional air systems.

The airflow provided by the personal fan apparatus is also controlled to provide adequate comfort to an individual. Most air conditioning units or central air units force air in large quantities with the result to be an average temperature in a large area. This is often ineffective and can be troublesome in places such as hospitals that include curtains or other barriers, which may limit air flow or prevent proper air conditioning. The present invention overcomes these limitations by allowing the user to be in direct contact or in close proximity of the device while air is distributed. As the air is expelled, only a limited or gentle air transfer is needed due to the close nature of the device.

The present disclosure also contemplates a method for providing a portable source of air flow, comprising the steps of: providing a panel comprising a front and a back having at least one panel comprising a plurality of apertures connected to the front; connecting the panel to the support member; connecting the support member to a base; and locating a blower at the back of the panel, wherein the blower receives a signal from a controller unit and forces air through the panel and out of the apertures. The method may also comprise the steps of locating a heater at the back of the panel, wherein the heater is powered by the battery and receives a signal from the controller unit to heat air from the blower; locating a cooling unit at the back of the panel, wherein the cooling unit is powered by the battery and receives a signal from the controller unit to cool air from the blower; locating a cooling unit at the back of the panel, wherein the cooling unit is powered by the battery and receives a signal from the controller unit to cool air from the blower.

### BRIEF DESCRIPTION OF THE DRAWINGS

Examples of the personal fan apparatus are described with reference to the following drawing figures. The same numbers are used throughout the figures to reference like features and components.

FIG. 1 is a front view of the personal fan apparatus;

FIG. 2 is a side view of the personal fan apparatus wherein the arm comprises folding arms, and the panel is depicted in a position with the folding arms closed;

FIG. 3 is a rear view of the personal fan apparatus with as specified edge of the panel depicted in a horizontal configuration;

FIG. 4 is a rear view of the personal fan apparatus with the panel swiveled 90 degrees from the orientation of FIG. 3;

FIG. 5 is a side view of the personal fan apparatus depicting the arm and panel in a substantially perpendicular configuration relative to the support member.

### DETAILED DESCRIPTION OF THE DRAWINGS

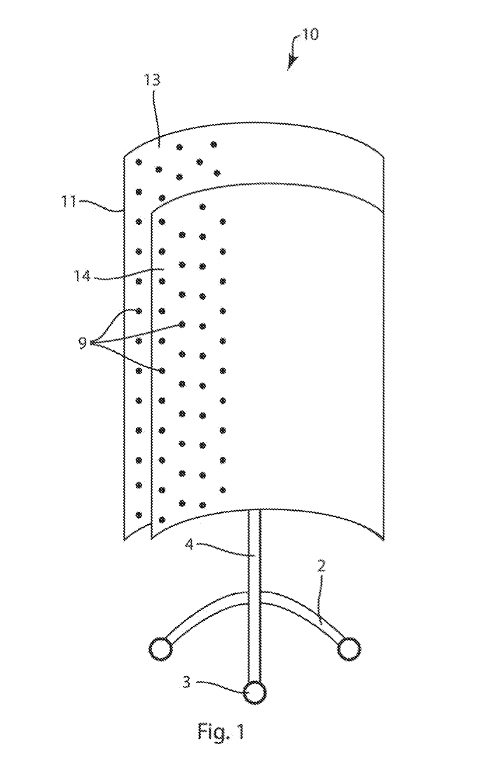

FIGS. 1-5 depicts an exemplary embodiment of a personal fan apparatus for providing a portable source of air flow in accordance with the present disclosure.

Referring to FIGS. 1-5, one embodiment of the personal fan apparatus 1 comprises a base 2, a plurality of casters 3, a support member 4, a panel 10, a blower 21, a heater 22, a cooling unit 23, and a controller unit 24. The personal fan apparatus 1 can be made of any suitable material including, but not limited to plastic and metal.

In one embodiment the base includes a plurality of casters 3, but may include any suitable device known in the art that allows the personal fan apparatus 1 to move across a horizontal surface. These suitable devices may include, but are not limited to wheels, casters, spheres, and balls, or any other device that permits movement across a horizontal surface. The base 2 is connected to a support member 4 for supporting the panel 10 and the other elements of the personal fan apparatus 1.

The panel 10 comprises a front 11 and a back 12 and defines an interior space. In the exemplary embodiment, the front 11 and back 12 take a concave shape. However, it is contemplated that the front 11 and back 12 may take different shapes and configurations. The front 11 comprises at least one plate 13. In the exemplary embodiment, the plate 13 takes a concave shape. It should be fully understood by persons skilled in the art that the panel 10 and plate 13 may take different configurations and shapes.

The plate 13 comprises a plurality of apertures 9. The apertures 9 expel air from the inside space of the panel 10. Air is moved through the apertures 9 by way of a blower 21 attached to the back 12 of the panel 10. Air from the blower 21 travels through the panel 10 before reaching the plate 13. The air contacts the backside of the plate 13 dispersing the air flow stream from the blower 21. As the air flow stream disperses, air is expelled through the apertures 9 located throughout the plate 13. Likewise, different orientations for apertures 9, as well as a different quantity or arrangement of plates may also be used.

As illustrated by FIG. 1 an exemplary embodiment comprises a plate 13 and a second plate 14. Adjusting the relative positions of the plate 13 and the second plate 14, varies the size and number of apertures 9 through which air from a blower may be expelled through the apertures 9. The second plate 14 may interact with the first plate 13 in any number of ways to permit adjustment, including magnets, clips, or other adjustable fastening devices.

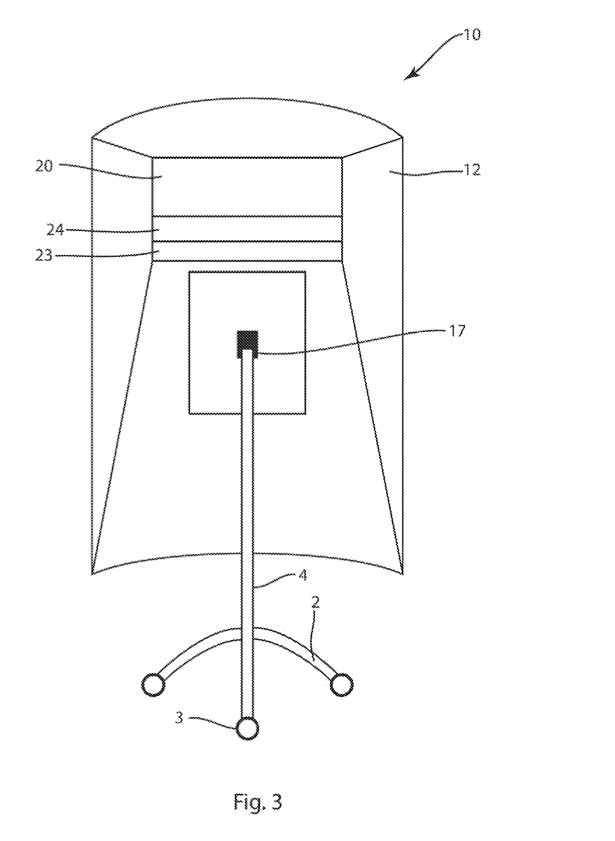

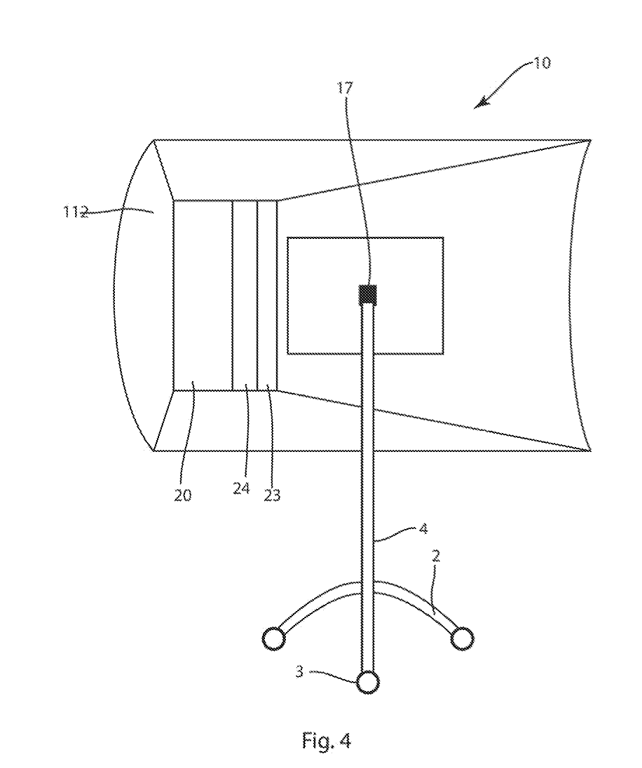

The rear view of the exemplary embodiment is shown in FIG. 3. FIG. 3 shows the rear view of the personal fan apparatus 1 in a substantially vertical orientation. This this embodiment, a connection member 17 connects the back 11 of the panel 10 to the support member 4. The connection member 17 allows the panel 10 to rotate about the support member 4. The connection member 17 also allows the panel to rotate about the connection member 17. FIG. 4 shows the panel 10 rotated to a substantially horizontal orientation. A locking feature of the connection member 10 allows the panel to be locked into a specific orientation. It should be understood that the panel 10 may be rotated relative to the support member 4 and connection member 17 to other orientations, such as the orientation shown in FIG. 4.

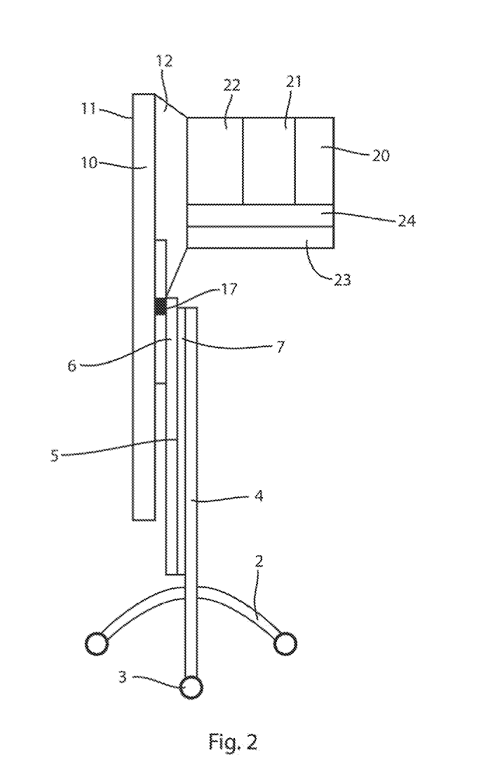

FIG. 2 shows an alternative embodiment of the personal fan apparatus 1. In this embodiment, the panel 10 in a substantially vertical orientation and the personal fan apparatus 1 is equipped with a folding arm 5 for connection between the support member 4 and the panel 10. The folding arm 5 comprises at least one section having a first end 6 and a second end 7. The folding arm 5 may also be comprised of multiple sections connected to one another (such as a hinge). The first end 6 is pivotally coupled to the panel 10. The second end 7 is pivotally coupled to the support member 4. In use, the folding arm 5 extends away from the support member 4 increasing the distance between the support member 4 and the panel 10. The folding arm 5 maintains its position once set by the user. It should be fully understood that the folding arm 5 may be configured and orientated in other ways known in the arts.

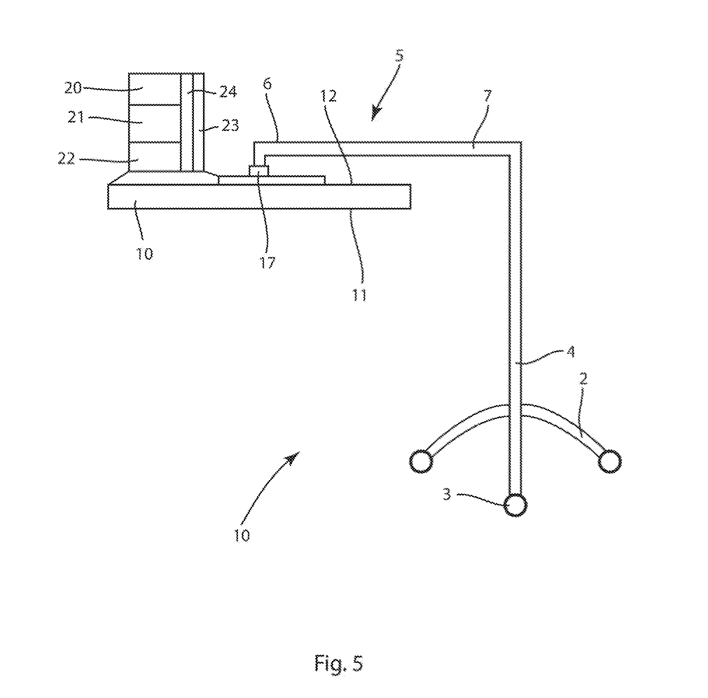

FIG. 5 shows a side view of the alternate embodiment of the personal fan apparatus 1. The folding arm 5 has been positioned away from the support member 4 and the panel 10 has been rotated in such as way that the front 12 of the panel is parallel with the horizontal surface.

It is further contemplated that the personal fan apparatus 1 may constructed in such a way that individual components or combinations of components referenced herein can be easily disassembled for storage or moving the personal fan apparatus 1. For instance, the panel may be removed from the connection member 17 and reconnected at a later time.

The controller unit 23 is configured to selectively activate the blower 20. The controller unit 23 may also selectively activate a heater 21 and/or cooling unit 22 when these components are included with the personal fan apparatus 1. The controller unit 23 includes a programmable processor having a memory and an operating platform capable of receiving input data from a user and one or more sensors such as temperature, light, and the like. In the exemplary embodiment, controller unit 23 is connected to the back 11 of the panel 10. Alternately, the controller unit 23 can be located remotely from the panel 10 and communicatively coupled to the blower 20, heater 21, and cooling unit 22. The communication may be achieved by an optional user input device and one or more sensor by a wireless link, including for example a LAN, WLAN, internet, intranet connection or the like. For instance, the controller unit 23 may include a wireless user remote. The controller unit includes a least one switch that allows a user to initiate and stop signals to components of the personal fan apparatus 1.

In operation, the controller unit 23 provides signals to the blower 23, heater 21 and/or cooling unit 22, as is well known in the art. The controller unit 23 signals the blower 20 to begin moving ambient from the area surround the personal fan apparatus 1. The controller unit 23 may also signal the blower to increase or decrease the amount of ambient air moving through the blower 23 and subsequently the panel 10. The blower 20 may be turned off after receiving a signal from the controller unit 23.

The heater 21 and cooling unit 22 also receive signals from the controller unit 23, as is well known in the art. A signal to the heater 21 may cause the heater to turn on, produce a hotter temperature in the air being moved by the blower 20, reduce the output of the heater 21, or turn off the heater 21. The cooling unit 22 may act in a similar way. The controller unit 23 may cause the cooling unit 22 to turn on, produce a cooler temperature in the air being moved by the blower 20, reduce the cooling output of the cooling unit 22, or turn off the cooling unit 22. The controller unit 23 may signal any component of the personal fan apparatus 1 individually or in combination.

In the exemplary embodiment, the controller unit 23 provides output data and instruction to control the operation of the blower 20, heater 21, and/or cooling unit 22. For instance, the controller unit 24 may increase the flow of air through the unit by increasing the output of the blower 20. The controller unit 23 may also increase or decrease the output from the heater 21 and/or cooling unit 22 to change temperature. The controller unit 23 may control any combination of blower 20, heater 21, and cooling unit 22.

In the exemplary embodiment, the personal fan apparatus 1 is powered by a battery 24. The battery is shown adjacent to the controller unit 23. However, it is contemplated that the battery 24 may be incorporated into the blower 20, heater 21, cooling unit 22, or a combination of these components. The battery 24 may be disposable, but in the exemplary embodiment the battery 24 is rechargeable. A charging cord connects the battery 25 to a power source (such as a wall outlet). The personal fan apparatus 1 may be operated While connected to a power source. The battery provides operability of the personal fan apparatus 1 while the personal fan apparatus 1 is not near a permanent power supply. The apparatus may be operable when connected to a power source, using battery power, or a combination of the two, for instance, when recharging a rechargeable battery.

In the present Description, certain terms have been used for brevity, clearness and understanding. No unnecessary limitations are to be implied therefrom beyond the requirement of the prior art because such terms are used for descriptive purposes only and are intended to be broadly construed. Various equivalents, alternatives and modifications are possible within the scope of the appended claims.

What is claimed is:

1. A personal fan, comprising:
a base for permitting movement across a horizontal surface;
a support member having a first end and a second end, wherein the first end of the support member is connected to the base;
a panel having a front and a back, the front comprising at least one plate having a plurality of apertures, and the panel connected to the support member;
a blower connected to the panel;
a controller unit; and
a battery;
wherein the blower receives a signal from the controller unit and forces ambient air through the panel and out of the apertures.

2. The personal fan of claim 1, further comprising,
a heater;
wherein the heater is powered by the battery and receives a signal from the controller unit to heat air from the blower.

3. The personal fan of claim 2, further comprising,
a cooling unit;
wherein the cooling unit is powered by the battery and receives a signal from the controller unit to cool air from the blower.

4. The personal fan of claim 1, further comprising,
a cooling unit;
wherein the cooling unit is powered by the battery and receives a signal from the controller unit to cools the air from the blower.

5. The personal fan of claim 1, wherein
the plurality of plates are adjustable relative to one another to vary the amount of air expelled from the panel.

6. The personal fan of claim 1, wherein
the controller unit includes a wireless user remote.

7. The personal fan of claim 1, wherein
the battery is rechargeable by connecting the battery to a power source.

8. A personal fan, comprising:
a base for permitting movement across a horizontal surface;
a support member having a first end and a second end, wherein the first end of the support member is connected to the base;
a folding arm having a first end and a second end, the first end connected to the support member;
a panel having a front and a back, the front comprising at least one plate having a plurality of apertures, and the panel connected to the folding arm;
a blower connected to the panel;
a controller unit; and
a battery;
wherein the blower receives a signal from the controller unit and forces ambient air through the panel and out of the apertures.

9. The personal fan of claim 8, further comprising,
a heater;
wherein the heater is powered by the battery and receives a signal from the controller unit to heat air from the blower.

10. The personal fan of claim 9, further comprising,
a cooling unit;
wherein the cooling unit is powered by the battery and receives a signal from the controller unit to cool air from the blower.

11. The personal fart of claim 8, further comprising,
a cooling unit;
wherein the cooling unit is powered by the battery and receives a signal from the controller unit to cool the air from the blower.

12. The personal fan of claim 8, wherein
the plurality of plates are adjustable relative to one another to vary the amount of air expelled from the panel.

13. The personal fan of claim 8, wherein
the controller unit includes a wireless user remote.

14. The personal fan of claim 8, wherein
the battery is rechargeable by connecting the battery to a power source.

15. The personal fan of claim 8, wherein
the folding arm is moveable relative to the support member.

16. The personal fan of claim 15, wherein
the folding arm maintains its position once set.

17. A method for providing a portable source of air flow, comprising the steps of:
providing a panel comprising a front and a back and having at least one panel comprising a plurality of apertures connected to the front;
connecting the panel to the support member;
connecting the support member to a base;
locating a blower at the back of the panel;
wherein the blower receives a signal from a controller unit and forces air through the panel and out of the apertures.

18. The method of claim 17, further comprising the steps of
locating a heater at the back of the panel,
wherein the beater is powered by the battery and receives a signal from the controller unit to heat air from the blower.

19. The method of claim 20, further comprising the steps of
locating a cooling unit at the back of the panel;
wherein the cooling unit is powered by the battery and receives a signal from the controller unit to cool air from the blower.

20. The method of claim 17, further comprising the steps of
locating a cooling unit at the back of the panel;
wherein the cooling unit is powered by the battery and receives a signal from the controller unit to cool air from the blower
